(19) United States
(12) Patent Application Publication
(10) Pub. No.: US 2011/0276785 A1
(43) Pub. Date: Nov. 10, 2011

(54) BYTE CODE CONVERSION ACCELERATION DEVICE AND A METHOD FOR THE SAME

(76) Inventors: Jong Sung Lee, Seoul (KR); Hyun Gyu Kim, Kyungki-do (KR); Kwan Young Kim, Kyungki-do (KR)

(21) Appl. No.: 13/143,909

(22) PCT Filed: Jan. 21, 2010
(86) PCT No.: PCT/KR2010/000375

§ 371 Date: Jul. 8, 2011

(30) Foreign Application Priority Data
Mar. 24, 2009 (KR) 10-2009-0024749

(51) Int. Cl. G06F 9/30; G06F 9/06

(52) U.S. Cl. 712/205; 712/209; 712/E09.003; 712/E09.016

(57) ABSTRACT

Provided is a bytecode conversion acceleration device and a method for the same: allowing a reduction in the size of a storage unit for a look-up table including a decoding table, a link table and a native code table; increasing the number of bytecodes that can be processed by hardware by using the look-up table to thereby enhance the overall performance of a virtual machine; and allowing an execution portion to immediately execute the first native code to thereby enhance performance of the virtual machine.

### BACKGROUND OF THE INVENTION

1. Field of the Invention

The present invention relates to a bytecode conversion acceleration device and a method for the same, and more particularly, to a bytecode conversion acceleration device and a method for the same, which can reduce a capacity of a look-up table storing native codes to be converted from a bytecode, and enhances performance of a virtual machine.

2. Description of the Related Art

Stack operation based Java, Dot net framework (.NET Framework), Actionscript, etc., that are object-oriented programming languages, can be moved between platforms and operating systems, respectively. Accordingly, they are widely used on the internet.

Java etc., is compiled into an intermediate language that is a Virtual Machine Language (VML) consisting of bytecodes that can be interpreted by a virtual machine. The bytecodes are executed by a virtual machine.

The virtual machine translates a bytecode, and converts the translated bytecode into a corresponding native code. The bytecode is not tied to a specific architecture. Thus, the bytecode has an advantage that it can be executed even in any architecture as long as a virtual machine exists. However, the virtual machine should convert a bytecode into a native code that is executed in a central processing unit. Thus, the virtual machine has a drawback that an execution speed is slow.

To improve the execution speed, a hardware accelerator that converts a bytecode into a native code obtained from a look-up table is being used.

FIG. 1 is a block diagram of a conventional bytecode conversion acceleration device and FIG. 2 is a configuration of a conventional look-up table.

As shown in FIGS. 1 and 2, the conventional bytecode conversion acceleration device 10 includes: a bytecode buffer 11 that receives bytecodes (BC) in sequence from a command cache portion 1 having stored the bytecodes and temporarily stores and outputs the received bytecodes (BC); a decoder 13 that receives the bytecodes (BC1) stored in the bytecode buffer 11 and decodes the received bytecodes (BC1), to thereby output a decoding signal (DO) indicating position of a look-up table 15 corresponding to the received bytecodes (BC1); the look-up table 15 that stores a bytecode length (BL) including an operation code and the number of operands, the total number (TNC) of native codes (NC) that are converted by each bytecode, a stack variation (SV) representing change of a stack by the bytecode to be executed, and the native codes (NC) that are converted according to each bytecode, and outputs state information (INF) and the native codes (NC) to be converted to an execution portion 3 in which the state information (INF) includes the bytecode length (BL), the total number (TNC) of the native codes (NC) and the stack variation (SV) that are stored in specific locations according to the decoding signal (DO); and a program counter updating portion 17 that adds the bytecode length (BL) stored in the look-up table 15 to a current program counter and outputs an updated program counter (NPC) indicating position of a bytecode to be fetched next from the command cache portion 1.

The conventional look-up table 15 stores the native codes (NC) to be converted from a corresponding bytecode. The native codes to be converted from each bytecode may overlap in may cases. For example, as shown in FIG. 2, it is assumed that the native codes (NC) to be converted are “a”, “b” and “c” in the first position of the look-up table 15, “a”, “b” and “d” in the second position thereof, and “a”, “b”, “c” and “f” in the third position thereof, it can be seen that the native code (NC) “a”, “b” or “c” that is executed in the execution portion 3 is a duplicated native code (NC) that should be converted upon receipt of the first, second and third bytecodes.

Thus, since the native codes are stored in duplication many times in the conventional look-up table, the number of the native codes to be stored in the look-up table increases, and a capacity of the look-up table that is a storage portion becomes large.

In addition, assuming a particular bytecode is twenty native codes (NC) in the conventional art, the look-up table 15 must have a space where the twenty native codes (NC) can be stored. Even in the case that the number of native codes to be converted is three, it is required that the number of spaces where the native codes are stored in the look-up table 15 should be twenty. As a result, this leads to waste of a memory unit. Thus, to prevent this, bytecodes whose number of native codes to be converted is large are processed in software programs, but only bytecodes whose number of native codes to be converted is riot more than a particular number are processed in hardware products by using the look-up table.

Thus, the number of native codes that can be stored in the look-up table is limited in the conventional art. As a result, the number of bytecodes that can be processed in hardware products by using the look-up table becomes small, and performance of a virtual machine is lowered.

### SUMMARY OF THE INVENTION

To overcome inconveniences of the conventional art, it is an object of the present invention to provide a bytecode conversion acceleration device and a method for the same, that can reduce a capacity of a look-up table including: a native code table that stores only non-overlapping native codes among native codes to be converted from all bytecodes; a decoding table that stores a bytecode length (BL), the total number (TNC) of native codes, a stack variation (SV), the first native code to be converted from each bytecode, and a link address; and a link table that stores a reference address of the native code table that stores the native codes to be converted excluding the first native code corresponding to each bytecode with reference to the link address of the decoding table, to thereby efficiently use a memory unit.

It is an object of the present invention to provide a bytecode conversion acceleration device and a method for the same, that can increase the number of bytecodes that can be processed in hardware products by using a look-up table whose capacity can be reduced, in comparison with the conventional art, to thereby enhance entire performance of a virtual machine.

It is an object of the present invention to provide a bytecode conversion acceleration device and a method for the same, in which the first native code stored in a decoding table is output to an execution portion if a decoding signal is output by a decoder, and thus the first native code is executed in the execution portion, to thereby enhance performance of a virtual machine.

To accomplish the above object of the present invention, according to an aspect of the present invention, there is provided a bytecode conversion acceleration device comprising:

a buffer that receives a bytecode from the command cache portion if an enable signal is activated, and stores the received bytecode;

a decoder that receives the bytecode stored in the buffer and decodes the received bytecode to then output a decoding signal;

a look-up table comprising: a decoding table that stores a bytecode length including an operation code and the number of operands, the total number of native codes that are converted by each bytecode, a stack variation representing change of a stack by the bytecode to be executed, and the first native code that is converted according to each bytecode, and a link address; a native code table that stores only non-overlapping native codes among native codes to be converted from all bytecodes stored in the command cache portion; and a link table that stores a reference address of the native code table that reads the subordinated native codes to be converted excluding the first native code corresponding to each bytecode with reference to the link address of the decoding table, to thereby output state information and the first native code to be converted to an execution portion in which the state information comprises the bytecode length, the total number of the native codes and the stack variation that are stored in the decoding table at a position selected according to the decoding signal;

a controller that reads reference addresses sequentially stored in the link table by the number of the subordinated native codes corresponding to each bytecode from a position selected according to the link address of the decoding table at a position selected according to the decoding signal, and sequentially outputs the native codes stored in the native code table selected according to the read reference addresses to the execution portion;

a counter that counts the number of the first native code and the subordinated native codes when the first native code and the subordinated native codes are sequentially output to the execution portion, and outputs an activated enable signal if there is no subordinated native codes to be converted; and

a program counter updating portion that adds the bytecode length stored in the decoding table to a current program counter and outputs an updated program counter indicating position of a bytecode to be received next from the command cache portion.

According to another aspect of the present invention, there is also provided a bytecode conversion acceleration method comprising:

a bytecode fetch step that sequentially fetches a bytecode from the command cache portion;

a decoding step that decodes the fetched bytecode that has been fetched in the bytecode fetch step, to then output a decoding signal;

a decoding table approximation step that comprises a decoding table that stores a bytecode length including an operation code and the number of operands, the total number of native codes that are converted by each bytecode, a stack variation representing change of a stack by the bytecode to be executed, and the first native code that is converted according to each bytecode, and a link address, to thereby output state information and the first native code to an execution portion in which the state information comprises the bytecode length, the total number of the native codes and the stack variation that are stored in the decoding table at a position selected according to the decoding signal, to then read the link address of the decoding table at the selected position;

a counter step that subtracts “1” from the total number of the native codes whenever the native codes are output to the execution portion, to thereby output the subtraction result;

a comparison step that determines whether or not the subtraction result is “0” in the counter step, to thereby control the bytecode fetch step to fetch a new bytecode if the subtraction result is “0”;

a link table approximation step that sequentially approximates the link table until the subtraction result is “0” from a position selected according to the link address of the decoding table at the position selected according to the decoding signal if the subtraction result is not “0” in the comparison step, to thereby read the reference addresses stored in the link table; and

a native code table approximation step that comprises a native code table that stores only non-overlapping native codes among native codes to be converted from all bytecodes stored in the command cache portion, to thereby output the native codes stored in the native code table corresponding to a position selected according to the reference address read in the link table approximation step to the execution portion.

### ADVANTAGEOUS EFFECTS

In the case of a bytecode conversion acceleration device and a method for the same, according to the present invention, since a native code table stores only non-overlapping native codes among native codes to be converted from all bytecodes, a capacity of a look-up table including the native code table, a decoding table and a link table can be formed in small size in comparison with the conventional art.

Accordingly, the present invention can increase the number of bytecodes that can be processed in hardware products by using a look-up table whose capacity can be reduced, in comparison with the conventional art, to thereby enhance entire performance of a virtual machine.

In addition, the first native code stored in a decoding table is output to an execution portion immediately if a decoding signal is output by a decoder, and thus the first native code is executed in the execution portion, to thereby performance of a virtual machine.

### BRIEF DESCRIPTION OF THE DRAWINGS

The above and/or other aspects of the present invention will become apparent and more readily appreciated from the following description of the exemplary embodiments, taken in conjunction with the accompanying drawings in which:

FIG. 1 is a block diagram of a conventional bytecode conversion acceleration device;

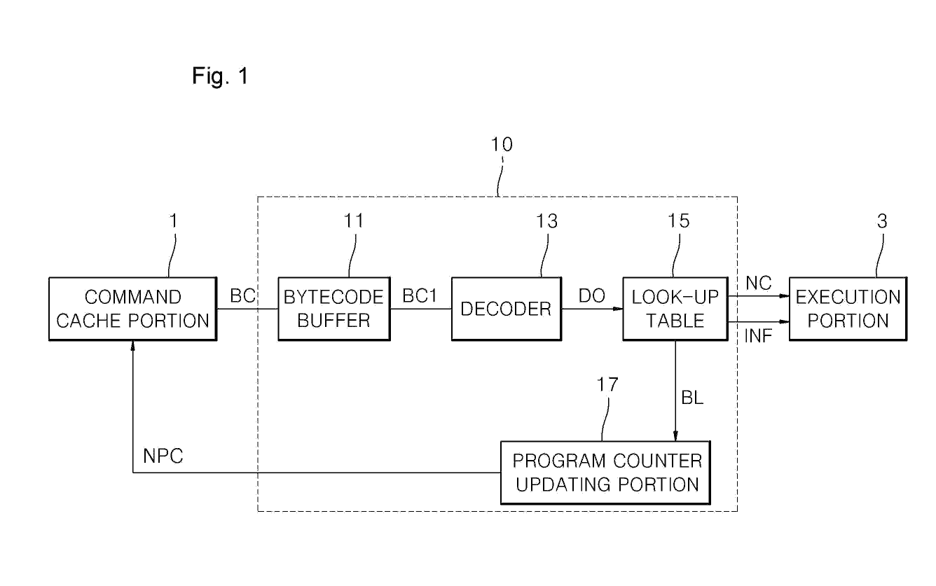

FIG. 2 shows a configuration of a conventional look-up table;

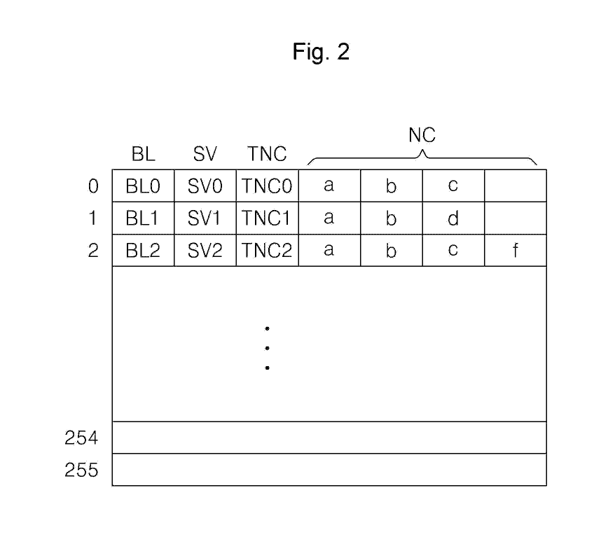

FIG. 3 is a block diagram of a bytecode conversion acceleration device according to the present invention;

FIG. 4 shows a configuration of a decoding table according to the present invention;

FIG. 5 shows a configuration of a link table that is applied in the present invention;

FIG. 6 shows a configuration of a native code table that is applied in the present invention;

FIG. 7 shows a configuration of a decoding table, a link table and a native code table for explaining operations of the present invention; and

FIG. 8 is a flowchart view for explaining a bytecode conversion acceleration method according to the present invention.

### DETAILED DESCRIPTION OF THE INVENTION

Hereinbelow, a bytecode conversion acceleration device and a method for the same according to the present invention will be described with reference to the accompanying drawings. Like reference numerals are assigned for like elements in the drawings.

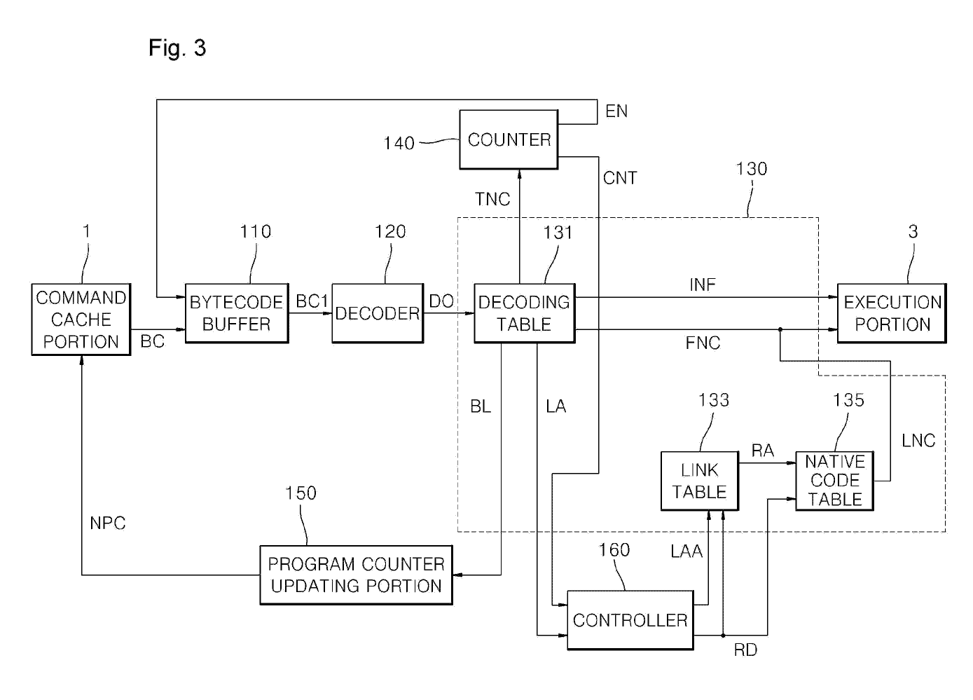

As shown in FIGS. 3 to 6, a bytecode conversion acceleration device includes: a buffer 110 that receives a bytecode (BC) from a command cache portion 1 if an enable signal (EN) is activated, and stores the received bytecode; a decoder 120 that receives the bytecode (BC1) stored in the buffer 110 and decodes the received bytecode to then output a decoding signal (DO); a look-up table 130; a controller 160; a counter 140 that counts the number of the first native code (FNC) and the subordinated native codes (LNC) when the first native code (FNC) and the subordinated native codes (LNC) are sequentially output to an execution portion 3, and outputs an activated enable signal (EN) if there is no subordinated native codes (LNC) to be converted; and a program counter updating portion 150 that adds the bytecode length (BL) stored in a decoding table 131 to a current program counter and outputs an updated program counter (NPC) indicating position of a bytecode to be received next from the command cache portion 1.

The look-up table 130 includes a decoding table 131, a link table 133, and a native code table 135.

The decoding table 131 stores a bytecode length (BL) including an operation code and the number of operands, the total number (TNC) of native codes (NC) that are converted by each bytecode, a stack variation (SV) representing change of a stack by the bytecode to be executed, and the first native code (FNC) that is converted according to each bytecode, and a link address (LA). The native code table 135 stores only non-overlapping native codes among native codes to be converted from all bytecodes stored in the command cache portion 1. The link table 133 stores a reference address (RA) of the native code table 135 that reads the subordinated native codes (LNC) to be converted excluding the first native code (FNC) corresponding to each bytecode with reference to the link address (LA) of the decoding table 131. Thus, the look-up table 130 outputs state information (INF) and the first native code (FNC) to the execution portion 3 in which the state information (INF) includes the bytecode length (BL), the total number (TNC) of the native codes (NC) and the stack variation (SV) that are stored in the decoding table 131 at a position selected according to the decoding signal (DO).

The controller 160 reads reference addresses (RA) sequentially stored in the link table 133 by the number of the subordinated native codes (LNC) corresponding to each bytecode from a position selected according to the link address (LA) of the decoding table 131 at a position selected according to the decoding signal (DO), and sequentially outputs the native codes stored in the native code table 135 selected according to the read reference addresses (RA) to the execution portion 3.

The counter 140 receives the total number (TNC) of the native codes (NC) stored in the decoding table 131 and subtracts “1” from the total number (TNC) of the native codes (NC) whenever the first native code (FNC) and the subordinated native codes (LNC) are sequentially output to the execution portion 3, and activates the enable signal (EN) if the subtraction result (CNT) is “0”.

In addition, the counter 140 subtracts “1” from the number of the subordinated native codes (LNC) whenever the subordinated native codes (LNC) are sequentially output to the execution portion 3, and activates the enable signal (EN) if the subtraction result (CNT) is “0”.

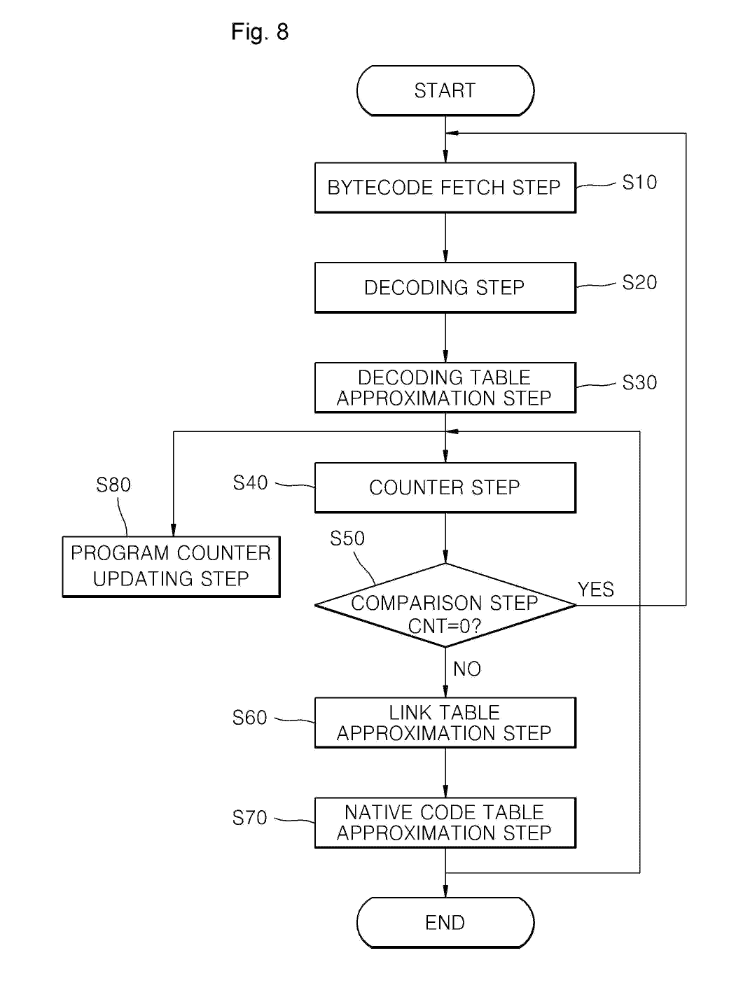

As shown in FIG. 8, a bytecode conversion acceleration method according to the present invention includes: a bytecode fetch step (S10) that sequentially fetches a bytecode (BC) from a command cache portion 1; a decoding step (S20) that decodes the fetched bytecode (BC) that has been fetched in the bytecode fetch step (S10), to then output a decoding signal (DO); a decoding table approximation step (S30) that includes a decoding table 131 that stores a bytecode length (BL) including an operation code and the number of operands, the total number (TNC) of native codes (NC) that are converted by each bytecode, a stack variation (SV) representing change of a stack by the bytecode to be executed, and the first native code (FNC) that is converted according to each bytecode, and a link address (LA), to thereby output state information (INF) and the first native code (FNC) to the execution portion 3 in which the state information (INF) includes the bytecode length (BL), the total number (TNC) of the native codes (NC) and the stack variation (SV) that are stored in the decoding table 131 at a position selected according to the decoding signal (DO), to then read the link address (LA) of the decoding table 131 at the selected position; a counter step (S40) that subtracts “1” from the total number (TNC) of the native codes (NC) whenever the native codes (NC) are output to the execution portion 3, to thereby output the subtraction result (CNT); a comparison step (S50) that determines whether or not the subtraction result (CNT) is “0” in the counter step (S40), to thereby control the bytecode fetch step (S10) to fetch a new bytecode if the subtraction result (CNT) is “0”; a link table approximation step (S60) that sequentially approximates the link table 133 until the subtraction result (CNT) is “0” from a position selected according to the link address (LA) of the decoding table 131 at the position selected according to the decoding signal (DO) if the subtraction result (CNT) is not “0” in the comparison step (S50), to thereby read the reference addresses (RA) stored in the link table 133; and a native code table approximation step (S70) that includes a native code table 135 that stores only non-overlapping native codes among native codes to be converted from all bytecodes stored in the command cache portion 1, to thereby output the native codes (NC) stored in the native code table 135 corresponding to a position selected according to the reference address (RA) read in the link table approximation step (S60) to the execution portion 3.

In addition, the bytecode conversion acceleration method according to the present invention further includes a program counter updating step (S80) that adds the bytecode length (BL) stored in the decoding table 131 to a current program counter and updates a program counter indicating position of a bytecode to be fetched next from the command cache portion 1.

Depending upon the above-described configuration of the bytecode conversion acceleration device and method according to the present invention operates as follows.

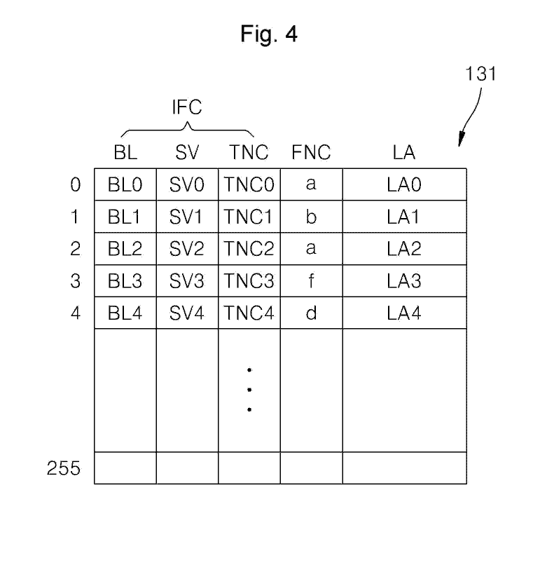

As shown in FIGS. 4 to 6, the look-up table 130 includes the decoding table 131, the link table 133, and the native code table 135.

As shown in FIG. 4, the decoding table 131 includes a storage portion having two hundred fifty six (256) addresses corresponding to a total of two hundred fifty six (256) bytecodes since the number of bytecodes stored in the command cache portion 1 is two hundred fifty six (256) in total. The bytecode (BC) is composed of an operation code and operands. The number of operands may vary according to the bytecode (BC), and the number of native codes to be converted may not be constant. In other words, the decoding table 131 stores a bytecode length (DL) including an operation code and the number of operands, the total number (TNC) of native codes (NC) that are converted by each bytecode, a stack variation (SV) representing change of a stack by the bytecode (BC) to be executed, and the first native code (FNC) among the native codes that is converted according to each bytecode (BC), and a link address (LA), for respective addresses of “0” to “255” so as to correspond to all bytecodes (BC) stored in the command cache portion 1.

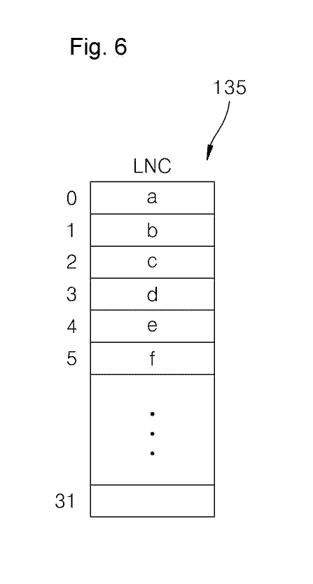

The native code table 135 stores only non-overlapping native codes (LNC) among native codes to be converted from all bytecodes (BC) stored in the command cache portion 1. In other words, as shown in FIG. 6, only overlapping native codes “a”, “b”, “c”, “d.”, “e”, “f”, etc., among the native codes (NC) to be converted are stored in the native code table 135.

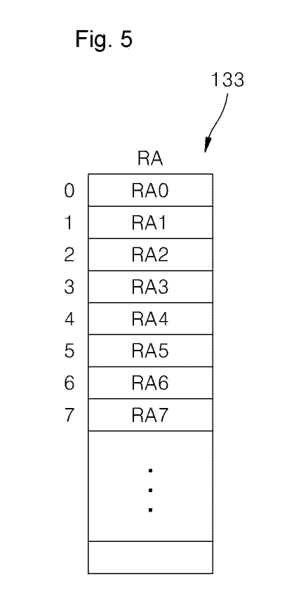

As shown in FIG. 5, the link table 133 stores a reference address (RA) of the native code table 135 that reads the subordinated native codes (LNC) to be converted excluding the first native code (FNC) corresponding to each bytecode with reference to the link address (LA) of the decoding table 131.

In general, native codes that are executed in the execution portion 3 may vary depending on structure of a processor in the execution portion 3. However, since the native codes are data of 8-bit, 16-bit, 32-bit or more, a capacity of a storage portion in the native code table 135 can be reduced to small size by storing only non-overlapping native codes in the native code table 135. Since the number of the non-overlapping native codes is considerably small, the number of bits of the reference address (RA) stored in the link table 133 is considerably small. That is, since the conventional look-up table stores all the native codes to be converted from each bytecode (BC), a capacity of the storage portion in the look-up table is large due to the overlapping native codes. However, a capacity of the look-up table 130 according to the present invention can be reduced in small size in comparison with the conventional art, to thereby efficiently use a memory unit. In addition, the number of the bytecodes that can be processed in hardware products can increase by using the look-up table, to thereby enhance the overall performance of a virtual machine.

In addition, the first native code (FNC) to be converted is stored in the decoding table 131, with respect to each bytecode (BC). Accordingly, if a decoding operation is performed in the decoder 120, the first native code (FNC) is output to the execution portion 3, to thereby make the execution portion 3 perform a command according to the first native code (FNC) and to thus enhance the performance of the virtual machine.

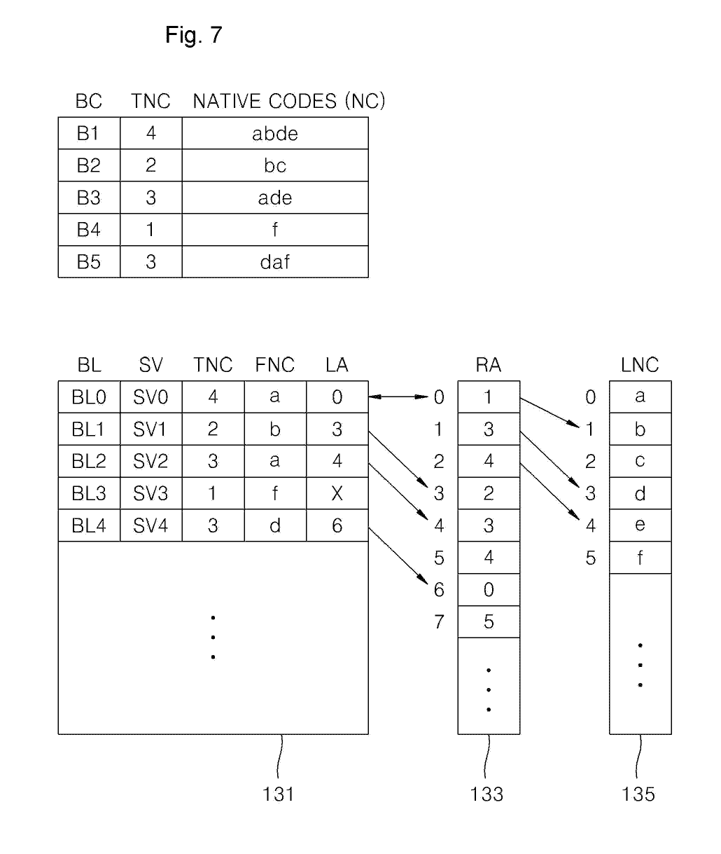

For example, as shown in FIG. 7, in the case of the first bytecode (B1) that is received from the command cache portion 1, the native codes (NC) to be converted are “a”, “b”, “d”, and “e”, the number (TNC) of the native codes is 4, the first native code (FNC) to be converted is “a”, and the subordinated native codes (LNC) to be converted are “b”, “d”, and “e” in sequence. In the case of the second bytecode (B2), the native codes (NC) to be converted are “b” and “c”, and the number (TNC) of the native codes is 2. In the case of the third bytecode (B3), the native codes (NC) to be converted are “a”, “d” and “e”, and the number (TNC) of the native codes is 3. In the case of the fourth bytecode (B4), the native code (NC) to be converted is “f”, and the number (TNC) of the native code is 1. In the case of the fifth bytecode (B5), the native codes (NC) to be converted are “d”, “a” and “f”, and the number (TNC) of the native codes is 3. The first bytecode (B1) outputs the decoding signal (DO) so as to be mapped to an address “0” of the decoding table 131 by the decoder 120, by assumption. Likewise, the second bytecode B2 is mapped to an address “1” of the decoding table 131, the third bytecode B3 is mapped to an address “2” of the decoding table 131, the fourth bytecode B4 is mapped to an address “3” of the decoding table 131, and the fifth bytecode 55 is mapped to an address “4” of the decoding table 131, by assumption. Under the circumstances, the operation of the bytecode conversion acceleration device and method according to the present invention operates as follows.

The buffer 110 receives the first bytecode (B1) stored in the command cache portion 1 and stores the received bytecode (B1), to then output the first bytecode (B1) to the decoder 120 (in a bytecode fetch step S10).

The decoder 120 decodes the received first bytecode (B1) to then output a decoding signal (DO) that is mapped to an address “0” of the decoding table 131 (in a decoding step S20).

A bytecode length (BL0), the total number (TNC) of “4” that is the number of the native codes (NC) to be converted from the first bytecode (B1), a stack variation (SV0) representing change of a stack, the first native code (FNC) of “a” that is converted according to each bytecode, and a link address (LA) “0” representing an address “0” of the link table 133, all of which are stored in an address “0” of the decoding table 131 according to the decoding signal (DO) are selected and output (in a decoding table approximation step S30).

The state information (INF) including the bytecode length (BL0), the total number (TNC) of the native codes (NC) and the stack variation (SV0) and the first native code (FNC) of “a” are transmitted to the execution portion 3. Then, the execution portion 3 executes the first native code (FNC).

The counter 140 receives the total number (TNC) of “4” that is the number of the native codes (NC), and subtracts “1” from the total number (TNC) of “4” when the first native code (FNC) is output to the execution portion 3. Accordingly, the subtraction result (CNT) of the current counter 140 is “3”. Here, since the subtraction result (CNT) is not “0”, the enable signal (EN) that is an output from the counter 140 is inactive. As a result, the buffer 110 does not receive the second bytecode (B2).

Since the link address (LA) stored in the decoding table 131 selected by the first bytecode (B1) is “0”, the controller 160 outputs a link table address (LAA) of an address “0” to the link table 133, and outputs an active read signal (RD) to the link table 133 and the native code table 135. Accordingly, the controller 160 reads the reference address (RA) “1” that is stored in the address “0” of the link table 133, and outputs the subordinated native code (LNC) of “b” that is stored in the address “1” of the native code table 135 by the reference address (RA) “1” that is stored in the link table 133 to the execution portion 3. In this case, the subtraction result (CNT) of the counter 140 has a value of “2” by subtracting “1” from “3”. Since the subtraction result (CNT) is “2”, the controller 160 continuously outputs the link table address (LAA) of an address “1” to the link table 133, and the active read signal (RD) to the link table 133 and the native code table 135. Accordingly, the controller 160 reads the reference address (RA) “3” that is stored in the address “1” of the link table 133, and outputs the subordinated native code (LNC) of “d” that is stored in the address “3” of the native code table 135 to the execution portion 3. In this case, the subtraction result (CNT) has a value of “1”. Likewise, since the subtraction result (CNT) is “1”, the controller 160 continuously reads the reference address (RA) “4” that is stored in the address “2” of the link table 133, and outputs the subordinated native code (LNC) of “e” that is stored in the address “4” of the native code table 135 to the execution portion 3. In this case, since the subtraction result (CNT) of the counter 140 is “0”, the enable signal (EN) that is an output from the counter 140 is active and the controller 160 makes the read signal (RD) inactive.

As described above, the first native code (FNC) of “a” is output to the execution portion 3 in the decoding table approximation step (S30). In the counter step (S40), the counter 140 subtracts “1” from the total number (TNC) that is the number of the native codes (NC) to be converted, when the native codes (NC) to be converted are output to the execution portion 3. Then, in the comparison step (S50), it is compared whether or not the subtraction result (CNT) is “0”. As a result, if the subtraction result (CNT) is “0”, the buffer 110 fetches the second bytecode (B2) stored in the command cache portion 1, but if the subtraction result (CNT) is not “0”, the link table approximation step (S60) sequentially approaches the link table 133 from a position selected according to the link address (LA) until the subtraction result (CNT) is “0”, and reads the reference addresses (RA) that are stored in the link table 133. In other words, in the case that the first bytecode (B1) is fetched, the reference addresses (RA) that are respectively stored in the addresses “0”, “1” and “2” of the link table 133 by the link address (LA) are read. In the native code table approximation step (S70), the native codes stored in the native code table 135 corresponding to the position selected according to the reference addresses (RA) read in the link table approximation step (S60) are output to the execution portion 3. The first native code (FNC) of “a” and the subordinated native codes (LNC) of “b”, “d” and “e” that are the remaining native codes to be converted excluding the first native code (FNC), which are four native codes to be converted from the first bytecode (B1), are sequentially output to the execution portion 3.

By the same method as described above, the remaining bytecodes are converted into the corresponding native codes, to then be output to the execution portion 3.

The counter 140 is configured to subtract “1” from the total number (TNC) of the native codes, but is configured to subtract “1” from the total number of the subordinated native codes (LNC) instead of the total number (TNC) of the native codes. In other words, since the total number of the subordinated native codes (LNC) is obtained by subtracting “1” from the total number (TNC) of the native codes, the counter 140 does not count to subtract “1” from the total number (TNC) of the native codes, when the first native code (FNC) is output to the execution portion 3, but count to subtract “1” from the total number (TNC) of the total number of the subordinated native codes (LNC) when the subordinated native codes (LNC) are output to the execution portion 3

In FIG. 7, since the fourth bytecode (B4) is converted into one native code, the link address (LA) stored in the decoding table 131 is meaningless. In other words, if the first native code (FNC) of “f” stored in the decoding table 131 is output to the execution portion 3, the subtraction result (CNT) of the counter 140 becomes “0”. As a result, the link table approximation step (S60) and the native code table approximation step (S70) are not performed, and a new bytecode will be fetched immediately.

The program counter updating portion 150 adds the bytecode length (BL) stored in the decoding table 131 to a current program counter and outputs an updated program counter (NPC) indicating position of a bytecode to be received next from the command cache portion 1.

The program counter updating portion 150 adds the bytecode length (BL) stored in the decoding table 131 to a current program counter and outputs an updated program counter (NPC) indicating position of a bytecode to be received next from the command cache portion 1.

As described above, the bytecode conversion acceleration device and method according to the present invention can reduce a capacity of the storage portion of the look-up table, in comparison with the conventional art. In addition, the present invention can increase the number of bytecodes that can be processed in hardware products by using a look-up table, in comparison with the conventional art, to thereby enhance entire performance of a virtual machine. In addition, the first native code is executed in the execution portion, to thereby enhance performance of a virtual machine at the time of conversion of the bytecode.

The present invention is not limited to the above-described embodiments. It is apparent to one who has an ordinary skill in the art that there may be many modifications and variations within the same technical spirit of the invention.

What is claimed is:

1. A bytecode conversion acceleration device that receives bytecodes (BC) in sequence from a command cache portion having stored the bytecodes and converts the received bytecodes into native codes (NC) corresponding to each bytecode that is executed in an execution portion, to then be output to the execution portion, the bytecode conversion acceleration device comprising:
a buffer that receives a bytecode (BC) from the command cache portion if an enable signal (EN) is activated, and stores the received bytecode;
a decoder that receives the bytecode (BC1) stored in the buffer and decodes the received bytecode (BC1) to then output a decoding signal (DO);
a look-up table comprising: a decoding table that stores a bytecode length (BL) including an operation code and the number of operands, the total number (TNC) of native codes (NC) that are converted by each bytecode, a stack variation (SV) representing change of a stack by the bytecode to be executed, and the first native code (FNC) that is converted according to each bytecode, and a link address (LA); a native code table that stores only non-overlapping native codes among native codes to be converted from all bytecodes stored in the command cache portion; and a link table that stores a reference address (RA) of the native code table that reads the subordinated native codes to be converted excluding the first native code corresponding to each bytecode with reference to the link address (LA) of the decoding table, to thereby output state information (INF) and the first native code (FNC) to be converted to the execution portion in which the state information (INF) comprises the bytecode length (BL), the total number (TNC) of the native codes (NC) and the stack variation (SV) that are stored in the decoding table at a position selected according to the decoding signal (DO);
a controller that reads reference addresses (RA) sequentially stored in the link table by the number of the subordinated native codes (LNC) corresponding to each bytecode from a position selected according to the link address (LA) of the decoding table at a position selected according to the decoding signal (DO), and sequentially outputs the native codes stored in the native code table selected according to the read reference addresses (RA) to the execution portion;
a counter that counts the number of the first native code (FNC) and the subordinated native codes (LNC) when the first native code (FNC) and the subordinated native codes (LNC) are sequentially output to the execution portion, and outputs an activated enable signal (EN) if there is no subordinated native codes (LNC) to be converted; and
a program counter updating portion that adds the bytecode length (BL) stored in the decoding table to a current program counter and outputs an updated program counter (NPC) indicating position of a bytecode to be received next from the command cache portion.

2. The bytecode conversion acceleration device according to claim 1, wherein the counter receives the total number (TNC) of the native codes (NC) stored in the decoding table and subtracts “1” from the total number (TNC) of the native codes (NC) whenever the first native code (FNC) and the subordinated native codes (LNC) are sequentially output to the execution portion, and activates the enable signal (EN) if the subtraction result (CNT) is “0”.

3. The bytecode conversion acceleration device according to claim 1, wherein the counter subtracts “1” from the number of the subordinated native codes (LNC) to be converted whenever the subordinated native codes (LNC) are sequentially output to the execution portion, and activates the enable signal (EN) if the subtraction result (CNT) is “0”.

4. A bytecode conversion acceleration method that fetches bytecodes (BC) in sequence from a command cache portion having stored the bytecodes and converts the fetched bytecodes into native codes (NC) corresponding to each bytecode that is executed in an execution portion, to then be output to the execution portion, the bytecode conversion acceleration method comprising:
a bytecode fetch step (S10) that sequentially fetches a bytecode (BC) from the command cache portion;
a decoding step (S20) that decodes the fetched bytecode (BC) that has been fetched in the bytecode fetch step, to then output a decoding signal (DO);
a decoding table approximation step (S30) that comprises a decoding table that stores a bytecode length (BL) including an operation code and the number of operands, the total number (TNC) of native codes (NC) that are converted by each bytecode, a stack variation (SV) representing change of a stack by the bytecode to be executed, and the first native code (FNC) that is converted according to each bytecode, and a link address (LA), to thereby output state information (INF) and the first native code (FNC) to the execution portion in which the state information (INF) comprises the bytecode length (BL), the total number (TNC) of the native codes (NC) and the stack variation (SV) that are stored in the decoding table at a position selected according to the decoding signal (DO), to then read the link address (LA) of the decoding table at the selected position;
a counter step (S40) that subtracts “1” from the total number (TNC) of the native codes (NC) whenever the native codes (NC) are output to the execution portion, to thereby output the subtraction result (CNT)
a comparison step (S50) that determines whether or not the subtraction result (CNT) is “0” in the counter step (S40), to thereby control the bytecode fetch step (S10) to fetch a new bytecode if the subtraction result (CNT) is “0”;
a link table approximation step (S60) that sequentially approximates the link table until the subtraction result (CNT) is “0” from a position selected according to the link address (LA) of the decoding table at the position selected according to the decoding signal (DO) if the subtraction result (CNT) is not “0” in the comparison step (S50), to thereby read the reference addresses (RA) stored in the link table; and
a native code table approximation step (S70) that comprises a native code table that stores only non-overlapping native codes among native codes to be converted from all bytecodes stored in the command cache portion, to thereby output the native codes (NC) stored in the native code table corresponding to a position selected according to the reference address (RA) read in the link table approximation step (S60) to the execution portion.

5. The bytecode conversion acceleration method of claim 4, further comprising a program counter updating step (S80) that adds the bytecode length (BL) stored in the decoding table to a current program counter and updates a program counter indicating position of a bytecode to be fetched next from the command cache portion.
